(19) United States
(12) Patent Application Publication
(10) Pub. No.: US 2026/0160324 A1
(43) Pub. Date: Jun. 11, 2026

(54) LOW-MAINTENANCE SEAL ASSEMBLY FOR A VERTICALLY ALIGNED INDUSTRIAL GEARBOX

(71) Applicant: Flender GmbH, Bocholt (DE)

(72) Inventors: Christoph BRUNS, Bocholt (DE); Michael KLEIN-HITPASS, Bocholt (DE); Michael TEGELKAMP, Bocholt (DE); Guido JOSTEN, Bocholt (DE)

(73) Assignee: Flender GmbH, Bocholt (DE)

(21) Appl. No.: 18/707,350

(22) PCT Filed: Nov. 2, 2022
(86) PCT No.: PCT/EP2022/080486

§ 371 Date: May 3, 2024

(30) Foreign Application Priority Data
Nov. 4, 2021 (EP) 21206455.4

(51) Int. Cl. F16H 57/029; B29C 64/386; B29L 31/26; B33Y 50/00; B33Y 80/00; F16H 1/28; F16H 57/031; F16H 57/04; G05B 19/4099

(52) U.S. Cl. CPC F16H 57/029; B29C 64/386; B33Y 50/00; B33Y 80/00; F16H 57/031; F16H 57/042; F16H 57/0471; G05B 19/4099; B29L 2031/26; F16H 1/28; G05B 2219/35134; G05B 2219/49023

(57) ABSTRACT

A seal assembly for an industrial transmission includes a vertically aligned lower power shaft to exchange torque with the industrial transmission, and a transmission component arranged radially outside the power shaft. The power shaft has a greater rotational speed than the transmission component during operation. A contactless first seal between the transmission component and the power shaft includes a conical first sealing gap, which is beveled in a direction of gravity and runs from radially outside to radially inside counter to the direction of gravity. A first overflow channel runs downward to at least a large extent in the direction of gravity and communicates with the first sealing gap. The first overflow channel ends below the first sealing gap in the direction of gravity and is embodied as an annular gap with a substantially constant flow cross section such as to avoid formation of a labyrinth seal.

The invention relates to a seal assembly for a vertically aligned industrial transmission, which is particularly low-maintenance, and to an industrial transmission of this type, and to a data agglomerate for the virtual representation of objects of this type.

DE 10 2013 212 464 A1 discloses an Industrial transmission having two planetary gear stages for driving a vertical mill, in which the planetary gear stages have vertically aligned shafts and fixed ring gears. The transmission components of the planetary gear stages, which transmission components are movable relative to one another, are lubricated with lubricating oil and sealed toward the environment via a seal assembly.

A seal assembly for a vertically running turbine shaft of a gas turbine for driving a helicopter is known from GB 783 118 A, wherein the turbine shaft is driven by exhaust gases of the gas turbine and is connected at one end to a compressor for supplying fresh air to the gas turbine and at the other end to a transmission provided for driving a helicopter rotor. The turbine shaft is mounted in a fixed turbine housing via a rolling bearing. Below the rolling bearing, an annular trough is formed, from which a gap with a beveled profile counter to the direction of gravity runs as far as an upper end of a sleeve connected to the turbine shaft. A labyrinth seal having a plurality of pockets open to the sleeve and a plurality of gap seals formed between the pockets is formed on the sleeve.

There is a constant need to design industrial transmissions to be low maintenance and to have low wear in order to minimize costly downtimes.

It is the object of the invention to indicate measures permitting a low-maintenance industrial transmission.

The object is achieved by means of a seal assembly having the features of claim 1, an industrial transmission having the features of claim 14, and a data agglomerate having the features of claim 15. Preferred refinements are specified in the dependent claims and the description below, which can each represent an aspect of the invention individually or in combination. If a feature is presented in combination with another feature, this serves only for simplified presentation of the invention and is in no way intended to mean that this feature cannot also be a refinement of the invention without the other feature.

One aspect of the invention relates to a seal assembly for an industrial transmission, having a vertically aligned lower power shaft for exchanging torque with the industrial transmission, a transmission component of the industrial transmission, said transmission component being provided radially outside the power shaft, wherein the power shaft has a greater rotational speed than the transmission component during operation as intended, wherein a contactless first seal is provided between the transmission component and the power shaft, wherein the first seal has a conical first sealing gap which is beveled in the direction of gravity and runs from radially on the outside to radially on the inside counter to the direction of gravity, wherein the first sealing gap communicates with a first overflow channel running downward to at least a large extent in the direction of gravity, wherein the first overflow channel ends below the first sealing gap in the direction of gravity and, in particular in order to avoid a labyrinth seal, is in the form of an annular gap.

A leakage of lubricant, in particular lubricating oil, may occur in particular between components of the industrial transmission rotating relative to one another. To prevent this, contacting seals, such as a radial shaft sealing ring or a felt seal, can be provided. However, contacting seals wear out and have to be regularly maintained and replaced. This is problematic in particular in industrial transmissions, since high relative speeds, high forces and high temperatures leading to deformations of the components and increased wear of the contacting seals may occur there. In addition, a dust-resistant encapsulation is often provided in dust-intensive applications, such as a mill intended for shredding solids, and therefore the accessibility of wearing parts is in principle difficult and requires time-consuming maintenance. The use of contactless seals, which avoids contact between the components rotating relative to one another even at the relative speeds and temperatures occurring in an industrial transmission, has a low sealing effect due to the remaining relatively large sealing gap.

The Invention uses the finding that, in the case of a vertically aligned industrial transmission, in which, for example, a power shaft can introduce a driving torque from below upward into the interior of a transmission housing of the industrial transmission or an output torque from above downward out of the interior of the transmission housing of the Industrial transmission, gravity effects and/or centrifugal effects can be used to improve the sealing effect of a contactless seal.

If the lubricant provided in the vertically aligned industrial transmission is intended to pass through the seal assembly, the lubricant would have to be moved along the first seal gap of the contactless first seal counter to the direction of gravity. The sealing effect of the first seal can thus be easily adjusted to a sufficient magnitude in the vertical direction over a corresponding large extent. In the case of a structural design of the first seal, which can be produced very simply and cost-effectively in comparison to a labyrinth seal, a high sealing effect can be achieved. The first sealing gap can be bounded at least in a predominant partial region in particular by two conical surfaces which are to face each other, are to be simple to manufacture and can form a constant radial distance between the conical surfaces, which are to face each other, at least in a partial region along the direction of flow of the first sealing gap. Owing to the beveled profile of the sealing gap, the mean diameter of the first sealing gap along the direction of flow counter to the direction of gravity is reduced, as a result of which the flow cross section in the first sealing gap is automatically reduced by a simple structural measure along the designated direction of flow counter to the direction of gravity. In the event of a leak via the first sealing gap, leaking lubricating oil would therefore have to struggle not only against gravity but also against a gradually increasing flow resistance as a result of the reduction in the flow cross section. Since, however, between the conical surfaces of the first sealing gap that are to face each other the distance between the conical surfaces can be kept substantially constant at the same time, unnecessary capillary effects can be avoided despite the decreasing flow cross section. The conical surfaces can, in particular, run substantially parallel to each other at least in a partial region and/or with a slightly beveled profile in a different partial region. The distance between the conical surfaces may be selected in particular in such a way that an aspirating capillary effect is avoided or kept low and/or a passage through the first sealing gap by high-splashing lubricant is blocked or kept low. The sealing gap between the conical surfaces may have a substantially constant flow cross section and/or a flow cross section tapering and/or expanding counter to the direction of gravity at least in one particular partial region.

Should lubricant pass through the first sealing gap of the first contactless seal, this usually very small proportion of lubricant can be removed from the first seal via the overflow channel which is designed as an annular gap and acts in particular as a gap seal. The overflow channel is in the form of an annular gap between the power shaft and a component connected to the transmission component, in particular the first sealing cover. The overflow channel in particular has a substantially constant flow cross section, with optionally provided transitions at the beginning and/or at the end of the overflow channel not being taken into consideration with respect to the constant flow cross section. The overflow channel can thus act as a particularly simply designed gap seal, wherein a labyrinth seal which is more complicated to produce and more complicated to maintain and which has a plurality of annular pockets formed between every two subsequent radially protruding webs, can be avoided. Preferably, the overflow channel consists of a single gap seal, in particular for the purpose of avoiding a labyrinth seal. The overflow channel may have a cylindrical outer channel wall running at least over a large part of the vertical extent, preferably over the entire vertical extent, of the overflow channel and a cylindrical inner channel wall running over the entire vertical extent of the overflow channel, wherein in particular the inner channel wall is formed by the power shaft itself, that is, it is not formed by a sleeve connected to the power shaft. Preferably, the outer channel wall of the overflow channel and the radially inner (conical) surface of the first sealing gap is formed integrally with a common component, in particular a first sealing cover, wherein, in particular, this common component has an annular collecting volume for collecting lubricant below the bearing and below the first sealing gap.

In addition, when the power shaft rotates during operation as intended, a relative rotation between the radially inner and radially outer boundary of the first sealing gap may occur. The lubricant penetrating the first sealing gap can be carried along by the radially inner and/or radially outer boundary of the first sealing gap due to friction effects and distributed over the circumferential surface, as a result of which the lubricant can flow back driven by gravity to the associated boundary. In addition, as a result of the rotational movement portion, the lubricant can be pressed radially outward driven by centrifugal force and pressed downward along the oblique plane formed by the radially outer boundary of the first sealing gap. In addition to the gravity acting in any case on the lubricant, a portion of the centrifugal force acting on the lubricant, which portion is directed along the oblique plane of the radially outer boundary of the first sealing gap, can transport the lubricant in the direction of gravity from the first sealing gap downward. As a result, It should be anticipated that, during regular operation, virtually no lubricant can pass through the first sealing gap and reaches the overflow channel. Therefore, it is sufficient to design the overflow channel as a simple annular gap with an effect as a sealing gap and to avoid a labyrinth seal, since even a low flow resistance at the upper end of the overflow channel as a result of the small radial extent of the overflow channel is sufficient to delay penetration of the lubricant into the overflow channel for as long as the the lubricant is conveyed back radially outward to the first sealing gap from the overflow channel because of centrifugal force effects. Even if lubricant enters the first sealing gap of the first seal counter to gravity, the simple but effective shape of the first sealing gap can convey the lubricant back radially outward and downward without wear effects, and therefore, with the aid of the seal assembly, a low-maintenance and cost-effective Industrial transmission is possible.

The power shaft can transmit a torque by means of an outer shell, provided in particular by a transmission housing, of the industrial transmission at the lower end of the outer shell. In particular, the power shaft can discharge a torque, which is converted in the industrial transmission as an output shaft, from the industrial transmission and drive, for example, a mill shaft of a vertical mill. However, it is also possible for the power shaft to be able to be connected to a drive motor and, as a drive shaft, to introduce a torque into the industrial transmission. The power shaft of the industrial transmission may in particular be a sun shaft connected to a sun gear of a planetary transmission or a planet carrier shaft connected to a planet carrier of the planetary transmission. The power shaft may be designed as a solid shaft or hollow shaft. The power shaft itself or a component connected to the power shaft may in particular form a boundary of the first sealing gap. In particular, the transmission component may be designed to be immovably fixed or so as to rotate more slowly than the power shaft. The transmission component may in particular be a ring gear of a planetary transmission and/or a transmission housing. Preferably, the industrial transmission has a planetary transmission with a fixed ring gear, which forms an outer shell of the industrial transmission radially on the outside and is connected on the end faces to in each case part of a fixed transmission housing. Preferably, a transmission housing provided above the transmission component in the direction of gravity can form a support for a drive motor or for a rotary plate, driven by the industrial transmission, of a vertical mill. Between the transmission component and the power shaft, which is rotatable relative thereto, in particular a bearing, preferably at least one rolling bearing, may be provided. The bearing may, for example, act on the transmission component and the power shaft or the transmission component and another component of the industrial transmission and mount them rotatably with respect to each other. The lubricant may be provided in particular for lubricating the bearing and, for example, pass from the bearing to the first seal because of gravity effects. The lubricant may be provided in addition or alternatively to the lubrication of toothing engagements of the industrial transmission and can reach the first seal by being displaced along tooth flanks and/or because of gravity effects.

In particular, the contactless first seal consists exclusively of only the one single first sealing gap. A cascade of a plurality of sealing gaps, as would be provided in a contactless labyrinth seal, can be deliberately avoided. A plurality of mutually spaced apart lamellae, each bounding a sealing gap offset from one another, can be avoided. The first seal can peter out in a conical first sealing gap. The outlay on production can thereby be minimized and/or a particularly robust and low-maintenance seal can be provided. The first seal is thereby designed particularly simply and cost-effectively with particularly few components. In particular, the first seal consists of precisely two components, each bounding one side of the first sealing gap.

If a vertical direction or a direction of gravity is assigned with respect to the industrial transmission and/or the seal assembly, this refers to the intended installation position, in which the center lines or axis of rotation of the transmission component and the power shaft are aligned in the vertical direction, Le. along the direction of gravity.

An industrial transmission is a transmission which is exposed to particularly high loads in industrial plants. In contrast to a turbomachine and/or helicopter drives, the industrial transmission has to withstand particularly high torques at comparatively lower rotational speeds. For this purpose, the industrial transmission is accordingly of solid design. A typical industrial transmission usually has a net weight of at least 500 kg, with typical industrial transmissions having a net weight of more than 1 t, in particular at least 5 t or at least 10 t. The power shaft, via which the power is introduced into the industrial transmission, is dimensioned for the power of the industrial transmission and therefore also has a very solid design, in particular a comparatively large diameter. The seal assembly for the power shaft is therefore of correspondingly large dimensions, especially with regard to the internal diameter. At the same time, the components, in particular the housing parts, in the vicinity of the power shaft and/or the industrial transmission can be accordingly of solid design, and therefore the seal assembly can be connected very easily and without major adjustments. Preferably, functional components of the seal assembly can be formed integrally by means of transmission components and/or housing parts which are provided in any case and are adapted only with regard to their shape for their functionality in the seal assembly. The Industrial transmission can be connected to a mechanical application, which involves, for example, a conveyor belt, with the aid of which recyclable materials from waste or the like, optionally previously separated and/or sorted, can be fed to a shredder. The mechanical application may also include, for example, a mill, vertical mill, sugar mill, cement mill, rock crusher, conveyor belt, pump, roller press, plate belt, pipe mill, rotary kiln, slewing gear, agitator, lifting device, garbage press, scrap press, shredder for recyclable materials from waste or the like, optionally previously separated and/or sorted.

In particular, a radially inner circumferential surface of the first sealing gap is fastened to the transmission component for rotation therewith and a radially outer circumferential surface of the first sealing gap is fastened to the power shaft for rotation therewith. The respective circumferential surface is formed in particular conically at least over a, preferably predominant, partial region, i.e., in particular as an outer conical stump or inner conical stump. The respective circumferential surface can form a boundary of the first sealing gap in the radial direction. Preferably, the respective circumferential surface extends over the entire vertical extent of the first sealing gap such that a separation joint within the respective circumferential surface is avoided. Since the transmission component is provided radially outside the power shaft, in particular coaxially, and the circumferential surface of the first sealing gap, which circumferential surface is directly or indirectly fastened to the transmission component, is provided at the radially inner boundary of the first sealing gap, a substantially U-shaped embracing of the circumferential surface of the first sealing gap, which circumferential surface is directly or indirectly fastened to the power shaft and forms the radially outer boundary, can be produced. This forms a chicane for the mass flow of the leaking lubricant, and therefore a reduction in the flow rate of the leaking lubricant, which makes it difficult to pass through the first sealing gap, is already achieved. In addition, high-splashing lubricant can be more easily retained by the material of the radially outer circumferential surface, which material embraces the radially inner circumferential surface, in particular in a substantially U-shaped manner and is connected to the power shaft. The material forming the radially outer circumferential surface can form a splash protection for the first sealing gap.

Preferably, the transmission component is mounted rotatably relative to the power shaft via a bearing bridging a bearing gap, wherein the first sealing gap communicates with the bearing gap. The lubricant, in particular lubricating oil, provided for the lubrication of the bearing, in particular rolling bearing, can be displaced out of the bearing and, in particular driven by gravity, can reach the first seal. For example, the bearing may have an inner ring and an outer ring which are rotatable about a vertically running axis, wherein the lubricant provided in the bearing can escape downward from the bearing in the direction of gravity. The lubricant can be retained in a volume between the bearing gap and the first sealing gap. In particular, at least some of the lubricant, which has nevertheless entered the first sealing gap, can be returned to this volume in a manner driven by gravity and/or driven by centrifugal force without external aids, i.e. passively. Preferably, with the volume provided between the bearing gap and the first sealing gap, oil return for active and/or passive removal of lubricant is provided. For example, the lubricant can be reused via the oil return to lubricate another component of the industrial transmission. Since it is scarcely possible for the lubricant escaping from the bearing to escape through the first sealing gap via the first contactless seal, it is possible to save on a sealing bearing cover for the bearing without having to be concerned about a significant leakage. This makes it possible to reduce the production costs and the number of components and outlay on maintenance.

Particularly preferably, a first sealing cover which is connected to the transmission component is provided, wherein the first sealing cover bounds at least part of the first sealing gap radially on the inside. The first sealing cover can bound a flow path of the lubricant and, in particular, form a U-shaped chicane for the lubricant on its inside facing the first sealing gap. The first sealing cover can be easily mounted by an axial relative movement relative to the material forming the radially outer boundary of the first sealing gap. The first sealing cover can be connected in particular via fastening means running in the axial direction, i.e., in particular substantially parallel to an axis of rotation of the power shaft, in particular screws, to the radially outer transmission component and/or a transmission housing. A separating joint of the first sealing cover from the transmission component and/or from the transmission housing can be offset radially outward and spaced apart from a lower base in the direction of gravity on the inside of the first sealing cover in such a way that the lubricant cannot reach the separating joint. This even makes it possible to save on a sealing element in the separating joint, which reduces the number of components. Alternatively, for safety reasons, a cost-effective sealing element, for example an O-ring or an annular paper seal, can be provided In the separating joint.

In particular, the first sealing cover has a first collecting volume, which is provided below the first sealing gap in the direction of gravity, for collecting lubricant. The first sealing cover can form the collecting volume on a lower base in the direction of gravity on the inside of the first sealing cover. Preferably, the lubricant can be actively or passively removed from the collecting volume, and therefore the risk of lubricant from the collecting volume entering the first sealing gap of the first contactless seal can be reduced. Owing to the collecting volume, the incoming lubricant can be collected at a distance from the first sealing gap in the direction of gravity, and therefore even high-splashing lubricant can hardly reach the first sealing gap. It may also be provided that at regular maintenance times, which are provided in any case, the first sealing cover is removed from the collecting volume to remove the lubricant collected since the last maintenance. Additionally or alternatively, it can also be provided that the lubricant collected since the last maintenance can be removed via a closable drain opening communicating with the collecting volume.

Preferably, the power shaft has an undercut first conical seat for the radially outer boundary of the first sealing gap. The first conical seat can be placed as a separate component onto the power shaft or formed integrally with the power shaft. The first conical seat can face radially inward and can embrace the material forming the radially inner boundary of the first sealing gap, in particular in a substantially U-shaped manner. The first conical seat can be produced cost-effectively, for example, by a machining process, in particular turning, in a radially outwardly protruding axial surface of the power shaft.

In particular, a first ramp for forming a larger flow cross section than in the first sealing gap is formed between the first sealing gap and the first overflow channel. For example, the gradient of the radially inner boundary of the first sealing gap with a transition into the ramp can change abruptly, for example via a kink, or gradually, for example via a rounding. Between the radially outer boundary of the first sealing gap, a, for example, funnel-like increase in the flow cross section from below upward can result in the direction of gravity above the radially inner boundary of the first sealing gap in a common height region with the ramp. Possibly present capillary effects in the first sealing gap can thereby be dispersed or at least reduced, and therefore material transport of the lubricant caused by capillary effects through the first sealing gap in the region of the ramp can be ended. The ramp can have a beveled profile with respect to the horizontal such that lubricant located on the ramp can flow back into the first sealing gap, driven by gravity. As a result, lubricant passing through the first sealing gap can automatically flow back, which can avoid or at least reduce leakage.

Particularly preferably, a radially outer channel wall of the first overflow channel, a/the radially inner circumferential surface of the first sealing gap and a collecting surface for the lower boundary of a/the first collecting volume, which is provided below the first sealing gap in the direction of gravity, for collecting lubricant are formed integrally, in particular by precisely one/the first sealing cover. The number of components can thus be kept low. In addition, use is made here of the finding that the integral component can be easily plugged onto the power shaft from below and can be easily fastened, in particular screwed, in the designated end position to the transmission component, in particular ring gear, and/or a fixed housing part. For this purpose, use can be made in particular of the first sealing cover which is provided in any case and is solid and stable enough in any case, when used in an Industrial application, in order to be able to form the shape required for this purpose. Since a sliding contact with the relatively rotating power shaft is avoided, the integral component can in particular also be made of plastic, and therefore by plastic injection molding of a plastic, in particular thermoplastic, the shape provided for the first sealing gap and the overflow channel can easily be achieved.

Preferably, an intermediate piece is connected to the power shaft for rotation therewith, wherein the Intermediate piece has an end face facing the first overflow channel for the gravity-driven and/or centrifugally driven discharge radially to the outside of lubricant coming from the first overflow channel. The lubricant dripping downward via the overflow channel can hit the lower end of the overflow channel on the end face of the intermediate piece. Since the intermediate piece is connected to the power shaft for rotation therewith, the end face of the intermediate piece can act as a spin disk and move the lubricant, driven by centrifugal force, radially outward from the power shaft. This prevents the lubricant from being transported to a separating joint between the intermediate piece and the power shaft, which could eventually lead to a leak. The end face of the intermediate piece can run in particular from radially on the inside to radially on the outside downward and beveled with respect to the horizontal, and therefore even when a power shaft is at a standstill and centrifugal forces are absent, the lubricant arriving at the end face can flow, driven by gravity, radially outward over the end face. For example, the lubricant can be collected at the radially outer end of the end face and/or guided so as to prevent leakage.

Particularly preferably, the power shaft has a step forming an axial stop for the intermediate piece, wherein a radial inside of the intermediate piece is provided radially further on the inside than the first overflow channel. By means of the at least small radial offset of the inside of the intermediate piece from the radially inner edge of the overflow channel, it can be ensured that lubricant arriving on the end face of the intermediate piece is conveyed away radially outward where the flow resistance is significantly lower than at the separating joint between the intermediate piece and the power shaft. In addition, the step forming the axial stop can specify the axial relative position of the intermediate piece with respect to the power shaft. Preferably, the intermediate piece is pressed onto the power shaft for rotation therewith and, for this purpose, pushed onto the power shaft until it strikes against the axial stop of the step.

In particular, a contactless second seal for providing a sealing resistance against lubricant passing the first seal is provided below the first seal between the transmission component and the power shaft in the direction of gravity, wherein in particular the second seal has a conical second sealing gap which is beveled in the direction of gravity and runs from radially on the outside to radially on the inside counter to the direction of gravity. The contactless second seal can be connected in particular in the flow direction of the lubricant to the first seal, the subsequent overflow channel and the subsequent end face of the intermediate piece. The contactless second seal may be designed in particular in the same way as the first seal described above. The above explanation of the first seal applies similarly to the second seal. The seal assembly can thus in particular be substantially two-stage with two contactless seals, each having a conical sealing gap, which can only be passed by the lubricant counter to the direction of gravity.

Preferably, it is provided that a radially inner circumferential surface of the second sealing gap is fastened to the transmission component for rotation therewith and a radially outer circumferential surface of the second sealing gap is fastened to the power shaft for rotation therewith, and/or a second sealing cover connected directly or indirectly to the transmission component is provided, wherein the second sealing cover bounds at least a part of the second sealing gap radially on the inside, and/or the second sealing cover has a second collecting volume, which is provided below the second sealing gap in the direction of gravity, for collecting and/or discharging lubricant, and/or the intermediate piece has a second undercut conical seat for the radially outer boundary of the second sealing gap, and/or the second sealing gap communicates with a second overflow channel running downward to at least a large extent in the direction of gravity, and/or a second ramp for forming a larger flow cross section than in the second sealing gap is formed between the second sealing gap and the second overflow channel. The second seal may thus be designed analogously to the first seal in parts or completely, with the proviso that the second seal is arranged below the first seal in the direction of gravity and the radially outer boundary of the second sealing gap is formed not by the power shaft itself, but by the intermediate piece connected to the power shaft. In addition, it is possible to provide the second seal on a smaller nominal diameter compared to the first seal. In addition, the second sealing cover can be fastened to the first sealing cover, and therefore the second sealing cover is only indirectly connected to the transmission component and/or the transmission housing.

Particularly preferably, an end seal communicating with the second sealing gap, in particular labyrinth seal or contacting seal, is provided below the second seal in the direction of gravity, wherein the end seal is provided on a smaller radius than the first sealing gap and the second sealing gap. The labyrinth seal is in particular greased. The end seal may be provided at a lower end of the transmission housing. This makes the end seal easier to access compared to the first seal and the second seal, and can make it easier and faster to maintain if necessary.

One aspect further relates to an industrial transmission, in particular for driving a vertical mill, having a vertically aligned power shaft for introducing a torque, wherein the power shaft is a planet carrier shaft or sun shaft of a planetary transmission, and having a transmission component, which rotates more slowly in comparison to the power shaft during use as intended or is at a standstill, wherein the transmission component is in the form of a ring gear and/or transmission housing of the planetary transmission, and having a seal assembly, which can be designed and developed as described above, for retaining lubricant. Even if lubricant enters the first sealing gap of the first seal counter to gravity, the simple but effective shape of the first sealing gap can convey the lubricant back radially outward and downward without wear effects, and therefore, with the aid of the seal assembly, a low-maintenance and cost-effective industrial transmission is possible. The industrial transmission can in particular otherwise be designed and developed as described in DE 10 2013 212 464A1, preferably in order to form a vertical mill, for example for shredding solids.

One aspect further relates to a data agglomerate with data packets combined in a common file or distributed across different files for representing the three-dimensional shape and/or the interactions of all of the constituent parts provided in the seal assembly, which can be designed and developed as described above, or in the industrial transmission, which can be designed and developed as described above, wherein the data packets are prepared, upon processing by a data processing device for operating a power tool for the additive manufacturing of devices, to carry out additive production of the constituent parts of the seal assembly, which can be designed and developed as described above, or of the industrial transmission, which can be designed and developed as described above, in particular by 3D printing, and/or, upon processing by a data processing device for carrying out a technical simulation, to carry out a simulation of the functioning of the seal assembly, which can be designed and developed as described above, or of the Industrial transmission, which can be designed and developed as described above, and to output simulation results generated in the process for further use, in particular for the purpose of providing fatigue strength verification depending on variable loads and/or variable temperature loadings. The data packets of the data agglomerate are specially adapted to the configuration according to the invention of the respective device in order to be able to adequately represent the interaction according to the invention of the constituent parts of the device according to the invention during processing in the data processing device. The data packets may be stored in particular in a spatially distributed manner, but may be adapted to one another in such a way that, in the case that all of the data packets are brought together in a common data processing device, the data agglomerate thus assembled provides all of the required data for additive manufacturing and/or a technical simulation with the aid of the data processing device for the device according to the invention. For example, the data packets are each separate parts of a data library, which are combined for the formation of the data agglomerate and are adapted to one another with respect to their dimensions relative to one another and/or absolute dimensions and/or material properties corresponding to the respective device according to the invention. The data agglomerate can represent a virtual embodiment of the respective device according to the invention, in particular the seal assembly and/or the industrial transmission, in the manner of what is referred to as a “digital twin”, which allows a virtual investigation in the form of a simulation or a real objectification by means of an additive manufacturing process. In particular, a data packet can in each case represent a separately executed constituent part of the respective associated device according to the invention, and therefore the individual constituent parts can be easily actually and/or virtually assembled in their relative position and/or relative movability to realize the interactions according to the invention. Using the data packets of the data agglomerate, in a virtual environment during a technical simulation of the individual constituent parts of the respective device and their interactions, the physical state and/or the change of physical parameters depending on different boundary conditions and/or over the time of the associated device according to the invention can be calculated and/or predicted and can be continued to be used for checking whether the device according to the invention is suitable enough for the intended use on the basis of the hypothetical configuration and taking into account the hypothetical simulated influences. In particular, it is possible, with the aid of the respective data packets, to generate the different constituent parts of the respective device separately and optionally from different materials by additive manufacturing and subsequently to assemble them to form a prototype of the respective device. The division of the data of the data agglomerate into different data packets thus makes possible in a simple manner a sequential additive manufacturing of constituent parts, which are movable relative to one another, of the device in question in the form of a kit of parts, which is prepared for the interaction according to the invention of the constituent parts of the prototype for solving the problem on which the invention is based to be assembled merely as expedient. This enables cost-effective production of prototypes and/or computer-based simulations to study the functioning of the seal assembly and/or the industrial transmission, identify problems in the specific application and find improvements. Even if lubricant enters the first sealing gap of the first seal counter to gravity, the simple but effective shape of the first sealing gap can convey the lubricant back radially outward and downward without any wear effects such that, using the seal assembly, a low-maintenance and cost-effective industrial transmission is made possible, which can be easily and cost-effectively checked with the aid of the data agglomerate.

Has been produced technique. Consequently, any method for producing such an object that is based on a rapid production technique de facto does not involve an inventive step, unless
strong arguments can be presented as to why a person skilled in the art would not take into consideration the production of such an object using the rapid manufacturing technique, or
the product itself has special structural features which represent an inventive value by them solving a particular problem, or
the production of the object using a rapid manufacturing method has unexpected effects, or
the product could be produced by no other known technology than a rapid manufacturing method.

None of the abovementioned requirements appears to be met in the case of the seal assembly claimed in the present application.

The invention will be explained below by way of example with reference to the accompanying drawings using preferred exemplary embodiments, wherein the features shown below can each represent an aspect of the invention both individually and in combination. In the drawings:

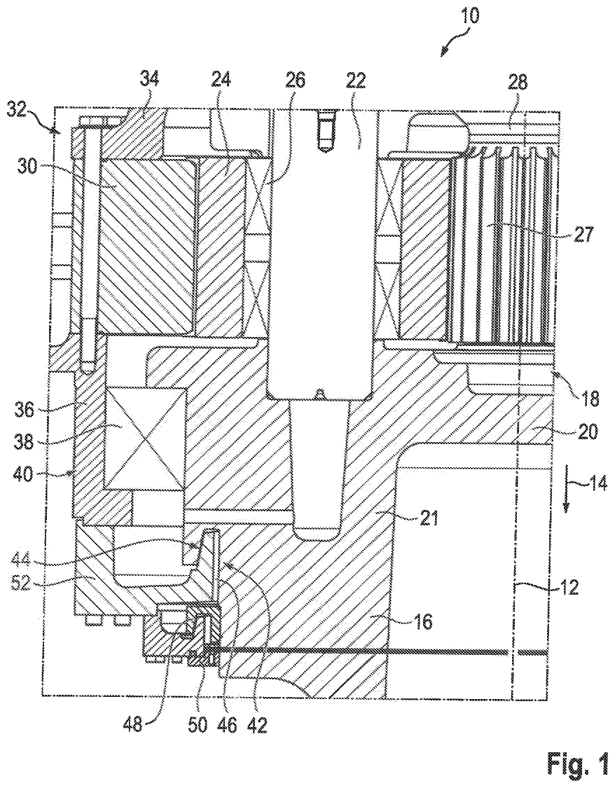

FIG. 1: shows a lower part of an industrial transmission,

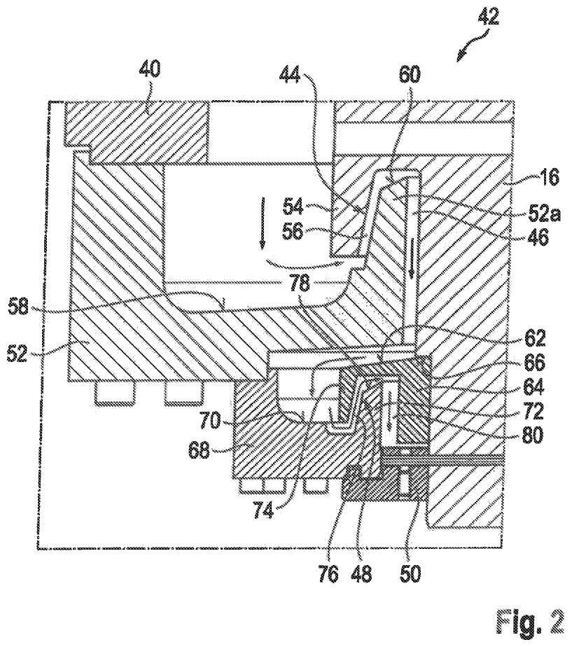

FIG. 2: shows a seal assembly provided for the industrial transmission from FIG. 1.

The industrial transmission 10 partially shown in FIG. 1 can be used in particular for a vertical mill for shredding solids. The industrial transmission 10 is substantially vertically aligned during use as intended, and therefore a main axis of rotation 12 is aligned along a direction of gravity 14. At the lower end of the industrial transmission 10 in the direction of gravity 14, a power shaft 16 used as an output shaft can discharge a torque, which is converted in the industrial transmission 10, from the industrial transmission 10. The Industrial transmission 10 has at least one planetary transmission 18, wherein preferably two or more planetary stages can be provided. The planetary transmission 18 forming a last planetary stage has a planet carrier 20, which is connected in particular integrally to a planet carrier shaft 21, which simultaneously forms the power shaft 16 in the illustrated exemplary embodiment. The planet carrier 20 has at least one planet gear axle 22 which is fastened to the planet carrier 20 for rotation therewith and on which a planet gear 24 is mounted relatively rotatably via a planet gear bearing 26 configured as a plain bearing or rolling bearing. Alternatively, the planet gear 24 may have a planet gear shaft which rotates with the planet gear 24 and can be mounted within a cheek of the planet carrier 20. In particular, at least three, preferably four, five, six or seven, planet gears 24 are provided. The respective planet gear 24 radially meshes internally with a sun gear 27, which is connected to a sun gear shaft 28 for rotation therewith. In the illustrated exemplary embodiment, via the sun gear shaft 28, a drive power which comes from a drive motor and which is optionally already converted in terms of rotational speed and torque by at least one upstream planetary stage of the industrial transmission 10 is transmitted via the planetary transmission 18 to the power shaft 16. The power shaft 16 can, as an output shaft, directly or indirectly transfer the converted drive power to a mill shaft of the vertical mill in order to rotate a mill plate. Radially on the outside, the respective planet gear 24 meshes with a ring gear 30, which runs more slowly in comparison to the power shaft 16. In the illustrated exemplary embodiment, the ring gear 30 is even fixed immovably and on its outside can form an outer shell of a transmission housing 32, from which the power shaft 16 protrudes. In the illustrated exemplary embodiment, the transmission housing 32 can be assembled by the ring gear 30 and an upper housing part 34 and a lower housing part 36. The upper housing part 34 can be fastened, in particular screwed, to an upwardly facing end face of the ring gear 30, wherein the upper housing part 34 can in particular have a support surface for supporting a drive motor of the vertical mill. The lower housing part 36 can be fastened, in particular screwed, to a downwardly facing end face of the ring gear 30, wherein the lower housing part 36 and thus also the ring gear 30 is mounted on the power shaft 16 via a bearing 38, in particular in the form of a rolling bearing. The ring gear 30 and the lower housing part 36 form a transmission component 40 of the industrial transmission 10, which is provided radially outside the power shaft 16.

The bearing 38 can be lubricated with a lubricant, in particular lubricating oil, with it being possible for lubricant to be displaced from the bearing 38 and being able to drip downward in the direction of gravity 14. In order to avoid leakage, the transmission component 40 and the power shaft 16 are part of a seal assembly 42, which has a contactless first seal 44 and a contactless second seal 48 which communicates via a first overflow channel 46 and to which finally an end seal 50 provided on a smaller radius is connected via a second overflow channel 80.

As illustrated in detail in FIG. 2, the seal assembly 42 has a first sealing cover 52, which can engage by an axial relative movement with a protruding first extension 52 into an undercut formed by the power shaft 16, wherein the undercut forms a first undercut conical seat 54. Between the first conical seat 54 and the first extension 52, a conical first sealing gap 56 of the first seal 44 is formed, which extends counter to the direction of gravity 14 and from radially on the outside to radially on the inside. The first sealing cover 52 can be fastened to a lower end face of the transmission component 40 and can bound a first collecting volume 58 into which the lubricant coming from the bearing 38 can drip. For a leakage of the lubricant it would be necessary for the lubricant from the first collecting volume 58 to pass the first sealing gap 56 of the first seal 44 counter to the direction of gravity 14. In addition, the first conical seat 54 forming the radially outer circumferential surface of the first sealing gap 56 can rotate with the rotational speed of the power shaft 16 and impress a centrifugal force on the lubricant that has reached the first sealing gap 56, owing to which the lubricant is conveyed radially outward and radially outward along the first conical seat 54 back into the first collecting volume 58. A first ramp 60 is connected to the upper end of the first sealing gap 56 and leads to a larger flow cross section than in the first sealing gap 56. Lubricant passing through the first sealing gap 56 can settle on the first ramp 60 and flow back into the first sealing gap 56, driven by gravity.

Even if lubricant should pass through the first seal 44, the lubricant can pass via the first overflow channel 46 on an upward facing end face 62 of an intermediate piece 64, which is fastened to the power shaft 16 for rotation therewith. The intermediate piece 64 is pressed on a smaller diameter than the first overflow channel 46 onto the power shaft 16 as far as a step 66. The end face 62 of the intermediate piece 64 is beveled with respect to the horizontal such that the incoming lubricant can flow radially outward via the end face 62, driven by gravity. In addition, the intermediate piece 64 can rotate with the rotational speed of the power shaft 16 and can assist the movement of the lubricant radially outward by means of impressed centrifugal forces. The lubricant can pass from the end face 62 of the intermediate piece 64 into a second collecting volume 70 bounded by a second sealing cover 68. The second sealing cover 68 can engage by an axial relative movement with a protruding second extension 72 into an undercut formed by the intermediate piece 64, wherein the undercut forms a second undercut conical seat 74. Between the second conical seat 74 and the second extension 72, a conical second sealing gap 76 of the second seal 48 is formed, which extends counter to the direction of gravity 14 and from radially on the outside to radially on the inside. The second sealing cover 68 may be fastened with a lower end face of the transmission component 40 and/or with a lower end face of the first sealing cover 52. For a leakage of the lubricant it would be necessary for the lubricant from the second collecting volume 70 to pass the second sealing gap 76 of the second seal 48 counter to the direction of gravity 14. In addition, the second conical seat 74 forming the radially outer circumferential surface of the second sealing gap 76 can rotate with the rotational speed of the power shaft 16 and impress a centrifugal force on the lubricant that has passed into the second sealing gap 76, owing to which the lubricant is conveyed radially outward and radially outward along the second conical seat 74 back into the second collecting volume 70. A second ramp 78 is connected to the upper end of the second sealing gap 76 and leads to a larger flow cross section than in the second sealing gap 76. Lubricant passing through the second sealing gap 76 can settle on the second ramp 78 and flow back into the second sealing gap 76, driven by gravity. Even if the lubricant should also pass through the contactless second seal 48 and be guided via a second overflow channel 80 to the end seal 50, the end seal 50, in the form for example of a greased labyrinth seal, can prevent leakage of the lubricant. In particular, the end seal 50 is designed only as a dust seal, which is intended to prevent the ingress of dust into the industrial transmission 10. Since only very little lubricant, if any at all, arrives at the end seal 50, a low sealing effect of the end seal against a leakage of lubricant is already sufficient.

What is claimed is:

1.-15. (canceled)

16. A seal assembly for an industrial transmission, the seal assembly comprising:
a vertically aligned lower power shaft designed to exchange torque with the industrial transmission;
a transmission component of the industrial transmission, the transmission component arranged radially outside the power shaft, wherein the power shaft has a rotational speed which is greater than a rotational speed of the transmission component during operation;
a contactless first seal provided between the transmission component and the power shaft and including a conical first sealing gap, which is beveled in a direction of gravity and runs from radially outside to radially inside counter to the direction of gravity; and
a first overflow channel running downward to at least a large extent in the direction of gravity and communicating with the first sealing gap, the first overflow channel designed to end below the first sealing gap in the direction of gravity and embodied as an annular gap with a substantially constant flow cross section such as to avoid formation of a labyrinth seal.

17. The seal assembly of claim 16, wherein the first sealing gap includes a radially inner circumferential surface in fixed rotative engagement with the transmission component, and a radially outer circumferential surface in fixed rotative engagement with the power shaft.

18. The seal assembly of claim 16, wherein the transmission component is mounted for rotation relative to the power shaft via a bearing designed to bridge a bearing gap, wherein the first sealing gap communicates with the bearing gap.

19. The seal assembly of claim 16, further comprising a first sealing cover connected to the transmission component and designed to bound at least part of the first sealing gap radially inside.

20. The seal assembly of claim 19, wherein the first sealing cover includes a first collecting volume below the first sealing gap in the direction of gravity, for collecting lubricant.

21. The seal assembly of claim 16, wherein the power shaft includes an undercut first conical seat for a radially outer boundary of the first sealing gap.

22. The seal assembly of claim 16, further comprising a first ramp arranged between the first sealing gap and the first overflow channel and designed to form a flow cross section which is larger than a flow cross section in the first sealing gap.

23. The seal assembly of claim 16, wherein the first overflow channel includes a radially outer channel wall and the first sealing gap includes a radially inner circumferential surface, the seal assembly further comprising a first collecting volume provided to collect lubricant and bounded at a lower area by a collecting surface, wherein the radially outer channel wall, the radially inner circumferential surface and the collecting surface are formed integrally.

24. The seal assembly of claim 23, further comprising a first sealing cover designed to integrally form the radially outer channel wall, the radially inner circumferential surface and the collecting surface.

25. The seal assembly of claim 16, further comprising an intermediate piece connected in fixed rotative engagement with the power shaft and including an end face in facing relationship to the first overflow channel for establishing a gravity-driven and/or centrifugally driven discharge radially outside of lubricant coming from the first overflow channel.

26. The seal assembly of claim 25, wherein the power shaft includes a step designed to form an axial stop for the intermediate piece, the intermediate piece including a radial inner side provided radially further inwardly than the first overflow channel.

27. The seal assembly of claim 16, further comprising a contactless second seal arranged below the first seal between the transmission component and the power shaft in the direction of gravity for providing a sealing resistance against lubricant passing the first seal, the second seal including a conical second sealing gap which is beveled in the direction of gravity and runs from radially outside to radially inside counter to the direction of gravity.

28. The seal assembly of claim 27, wherein the second sealing gap includes a radially inner circumferential surface in fixed rotative engagement with the transmission component, and a radially outer circumferential surface in fixed rotative engagement with the power shaft, and/or the sealing assembly further comprising at least one of:
a second sealing cover connected directly or indirectly to the transmission component and designed to bound at least a part of the second sealing gap radially inside and/or the second sealing cover including a second collecting volume below the second sealing gap in the direction of gravity, for collecting and/or discharging lubricant;
an intermediate piece connected in fixed rotative engagement with the power shaft and including an end face in facing relationship to the first overflow channel for establishing a gravity-driven and/or centrifugally driven discharge radially outside of lubricant coming from the first overflow channel, the intermediate piece including a second undercut conical seat for a radially outer boundary of the second sealing gap;
a second overflow channel running downward to at least a large extent in the direction of gravity and communicating with the second sealing gap; and
a second ramp formed between the second sealing gap and the second overflow channel and having a flow cross section which is larger than a flow cross section in the second sealing gap.

29. The seal assembly of claim 27, further comprising an end seal arranged below the second seal in the direction of gravity and communicating with the second sealing gap, the end seal provided on a radius which is smaller than a radius of the first sealing gap and the second sealing gap,

30. The seal assembly of claim 29, wherein the end seal is a labyrinth seal or contacting seal.

31. An industrial transmission, comprising:
a vertically aligned power shaft for introducing a torque, the power shaft being a planet carrier shaft or sun shaft of a planetary transmission;
a transmission component designed to rotate more slowly in comparison to the power shaft during operation or being at a standstill, the transmission component designed in a form of a ring gear and/or transmission housing of the planetary transmission; and
a seal assembly for retaining lubricant, the sealing assembly comprising the power shaft, the transmission component arranged radially outside the power shaft, a contactless first seal provided between the transmission component and the power shaft and including a conical first sealing gap, which is beveled in a direction of gravity and runs from radially outside to radially inside counter to the direction of gravity, and a first overflow channel running downward to at least a large extent in the direction of gravity and communicating with the first sealing gap, the first overflow channel designed to end below the first sealing gap in the direction of gravity and embodied as an annular gap with a substantially constant flow cross section such as to avoid formation of a labyrinth seal.

32. The industrial transmission of claim 31, constructed for driving a vertical mill.

33. A data agglomerate, comprising data packets combined in a common file or distributed across different files for representing a three-dimensional design and/or interactions of all constituent parts provided in the seal assembly as set forth in claim 16 or in an industrial transmission which comprises the seal assembly, the data packets being prepared to carry out additive production of the constituent parts of the seal assembly or of the industrial transmission, when being processed by a data processing device for operating a power tool for the additive manufacturing of devices and/or, when being processed by a data processing device for carrying out a technical simulation, to carry out a simulation of a functioning of the seal assembly or of the industrial transmission and to output simulation results generated in the process for further use.

34. The data agglomerate of claim 33, wherein the additive production of the constituent parts of the seal assembly or of the industrial transmission is carried out by 3D printing.

35. The data agglomerate of claim 33, wherein the simulation results are generated in the process for providing fatigue strength verification depending on variable loads and/or variable temperature loadings.
